(19) United States
(12) Patent Application Publication
(10) Pub. No.: US 2009/0313679 A1
(43) Pub. Date: Dec. 17, 2009

(54) PERSONAL TRAVEL ORGANIZER AND ONLINE TRAVELOGUE

(75) Inventors: Preston R. McAfee, San Marino, CA (US); Ravi Kumar, Santa Clara, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 12/139,326

(22) Filed: Jun. 13, 2008

(51) Int. Cl. H04L 9/32; G06F 3/048

(52) U.S. Cl. 726/3; 715/760

(57) ABSTRACT

A website may allow a user to create an online travelogue to reminisce about his trips, and then serve as a database for future travelers. The website may provide a variety of different templates to help users to organize and document elements of their trips. A user may select a template he prefers to start to create a record of his trip. A template may provide a layout for pictures and information about the flights he took, hotels he stayed at, places he visited, restaurants he went to, people he met, and other activities. The website may automatically abstract the user's flight information from a travel website and fill in the information at places for such information on the template. A user may drag pictures from an online photo management website and drop them on the template. The website may search the Internet according to the information from the user and provide pictures, videos and text for the user to put on the template. The website may allow a user to set his travelogue as public or private/password protected, and may pool the public travelogues together to provide references to later travelers.

### BACKGROUND

1. Field of the Invention

The present invention relates generally to online travelogues.

2. Description of Related Art

To help remember a vacation or a trip, people used to create a journal or travelogue on paper, combining pictures, tickets, brochures, and notes into one chronological display. With the growth of the Internet, people may create a travelogue with various online tools.

One of such online tools is blogging software. A user may open a new blog for a trip, and type in his itinerary, e.g., his destination, his flight number, and his departure and arrival time. He may input the name and address of the hotel he stayed at, or copy to his blog a link to the website of the hotel he stayed at, or of a museum he visited. The user may further drag and drop to his blog pictures taken during the trip from his local drive or an online album.

The user may have to input all information to the blog manually, making the process time consuming. In addition, there is no template that the user can follow to organize the information, and the user may only input the information randomly. He may leave out information about parts of his trip, and may find it is difficult to search for information about his trip later.

The user may build up his travelogue by creating a website or creating a Flickr™ page, but may face the same problems as with creating a blog.

Therefore, it may be desirable to provide a system and method which may help users to conveniently create an online travelogue and efficiently organize information about his trips.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates an example of a homepage of a travelogue website according to one embodiment of the present invention.

FIG. 2 illustrates an exemplary template of an online travelogue according to one embodiment of the present invention.

FIG. 3 illustrates a system for producing an online travelogue according to one embodiment of the present invention.

FIG. 4 illustrates a flow chart for producing an online travelogue according to one embodiment of the present invention.

### DETAILED DESCRIPTION

The present invention provides a website which may allow a user to create an online travelogue to reminisce about his trips, and then serve as a database for future travelers. The website may provide a variety of different templates to help users to organize and document elements of their trips. A user may select a template he prefers to start to create a record of his trip. A template may provide a layout for pictures and information about the flights he took, hotels he stayed at, places he visited, restaurants he went to, people he met, and other activities on the trip. The website may automatically abstract the user's flight information from a travel website and fill in the information at places for such information on the template. A user may drag pictures from an online photo management website and drop them on the template. The website may search the Internet according to the information from the user and provide pictures, videos and text for the user to put on the template. The website may allow a user to set his travelogue as public or private/password protected, and may pool the public travelogues together to provide references to later travelers. The invention may be carried out by computer-executable instructions, such as program modules. Advantages of the present invention will become apparent from the following detailed description.

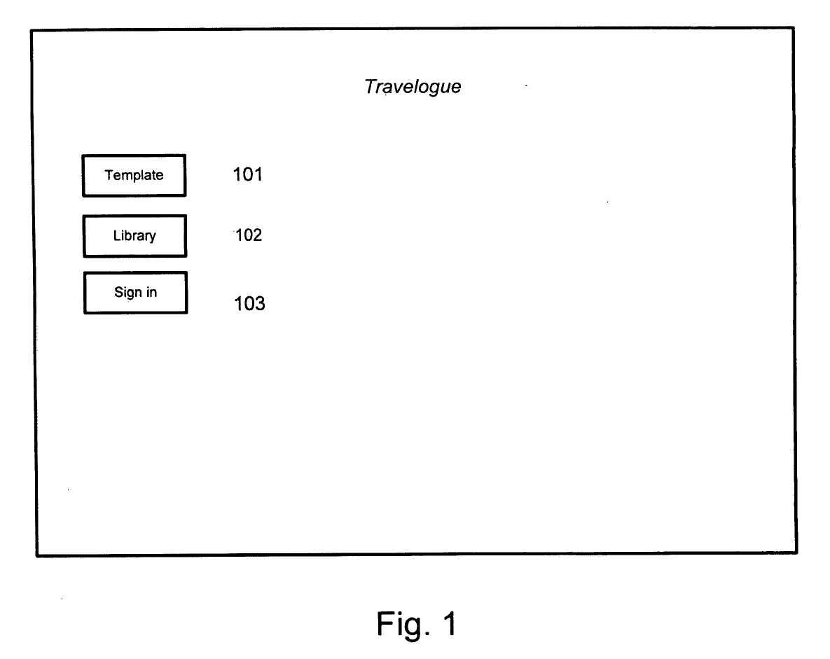

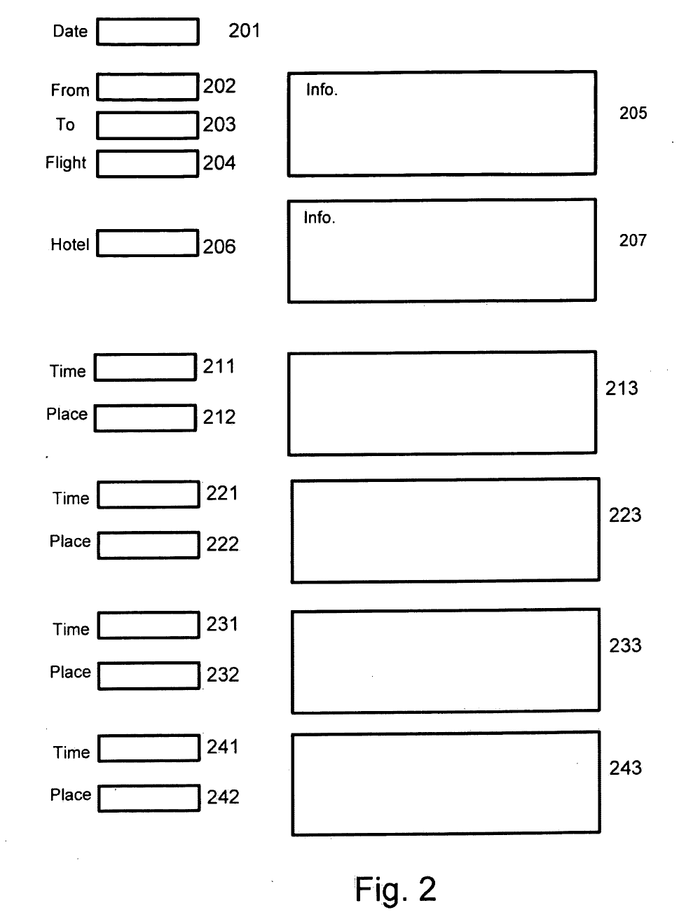

FIG. 1 illustrates an example of a homepage of a travelogue website according to one embodiment of the present invention. The homepage may have a Template button 101. When the Template button 101 is clicked on, a number of templates for travelogue may be displayed. Each template may have different layouts for users to input information and pictures about their trips. An exemplary template is illustrated in FIG. 2. The user may click on a template to select it and start a new travelogue.

The homepage may have a Library button 102. In one embodiment, when a user clicks on the Library button 102, a list of destinations may be displayed. If a user clicks on one of the destinations, public travelogues about that destination stored at travelogue website may be displayed, and the user may use these travelogues as references for his trip planning. In one embodiment, the destinations may be organized in several levels. In one embodiment, continents may be the first level, countries may be the second level, and states (or provinces) may be the third level, and cities may be the fourth level. In one embodiment, continents may be displayed as buttons in a pull-down menu under the Library button 102, and countries in a continent may be displayed when a user places his cursor on the button for the continent, and states (or provinces) in a country may be displayed when a user places his cursor on the button for the country, and cities in a state (or province) may be displayed when a user places his cursor on the button for the state (or province). In one embodiment, when a user clicks on the Library button 102, a world map may be displayed for the user to select a destination he is interested in.

The homepage may display a number of public travelogues saved at the travelogue website. The travelogues may be ordered according to their uploading time or their popularity, for example.

In one embodiment, a search box may be displayed on the homepage or subsequent web pages. A user may perform a word or text search for a particular travel segment, e.g., “New York” or “Museum,” to read about people's travel experiences there.

In one embodiment, a “Comment” button may be displayed on a web page displaying a travelogue. A user may add his comments about the travelogue to share his travel experiences. A facility may be provided to allow only authorized users to add comments. Alternatively, any user may be permitted to do so.

The homepage may have a Sign up button 103 for users to sign up for the service. A sign up page may be displayed when a user clicks on the Sign up button 103.

The homepage may have a Login button 104. A login page may be displayed if a user clicks on the Login button 104. In one embodiment, a user's personal page may be displayed after he inputs his login information on the login page. A user's personal page may include a list of travelogues he uploaded, both private travelogues and public travelogues. The user may click on any of his travelogues to look at or edit it. A user's personal page may further include a user's default template.

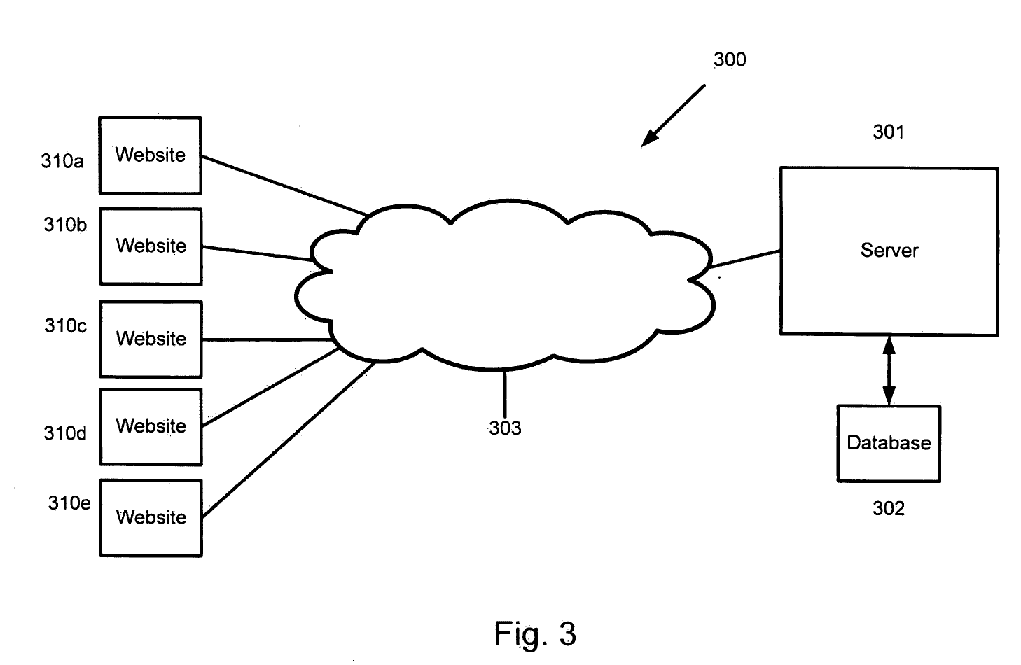

FIG. 2 illustrates an exemplary template of an online travelogue according to one embodiment of the present invention. As shown, the template may have a number of boxes for travel information, e.g., a Date box 201, a From box 202, a To box 203, a Flight/Ship/Train Information box 204, and a Hotel box 206. As described with reference to FIG. 3 below, a user's travel information may be automatically abstracted from the user's reservation information and imported in the boxes on the template. In one embodiment, the travelogue website may assign to each of its registered users an email address. When a user books his flights or hotels online, e.g., at travel.yahoo.com or www.expedia.com, he may use the email address from the travelogue website as an email address for receiving confirmations. A server 301 of the travelogue website, as shown in FIG. 3, may automatically abstract the travel date, flight and hotel information from the confirmation from the travel website, and import such information into the travel information boxes on the template respectively.

In one embodiment, when the From box 202, the To box 203 and the Flight/Ship/Train Information box 204 are filled in, a map may be displayed in an Information box 205 on the template, with the user's starting point, destination and airplane route highlighted.

In one embodiment, when the Hotel box 206 is filled in, the server 301 of the travelogue website may automatically obtain information about the hotel and insert the information about the hotel in an Information box 207. The Information box 207 may be a blank space for text and photos. The information about the hotel may be, e.g., a link to the official website of the hotel, a map with the location of the hotel marked, or other users' comments on the hotel. The user may delete all or part of the automatically inserted information if he does not like it. In one embodiment, the user may take some pictures at the hotel, and upload the pictures to an online photo management website, e.g., www.flickr.com. The server 301 of the travelogue website may automatically obtain photos taken at the hotel, by the user or other people, from the photo management website. The server may decide whether a picture is relevant to the hotel by information contained in the tag of the picture.

In one embodiment, the obtained pictures may be displayed in the Information box 207, and the user may delete the pictures he does not like. In one embodiment, the obtained pictures may be displayed in another window, e.g., a Flickr™ window, and the user may drag the pictures to the template and drop them there.

The template may have a number of sections for activities. Each section may have a Time box (e.g., 211, 221, 231, and 241), a Place box (e.g., 212, 222, 232, and 242) and a Notes box (e.g., 213, 223, 233, and 243). In one embodiment, each hour may be assigned a section. The Time box may be automatically filled in, but may be changed by a user if necessary. For example, if a user visited a museum from 1-5 pm, he may change the input in a Time box, e.g., 221, from “1 pm” to “1-5 pm,” input the name of the museum in the Place box 222, and write his experience at the museum in the Notes box 223. When the Place box 222 is filled in, the server 301 of the travelogue website may automatically pull up and display information about the museum and insert the information to the Notes box 223. The information may include a link to the official website of the museum, a map with the location of the museum marked, introduction of featured works of art displayed at the museum, pictures taken at the museum, or other users' comments on the museum. The pictures may be obtained from an online photo management website, and may be taken by the user or other people. In one embodiment, the pictures may be displayed in a separate window, e.g., a Flickr™ window.

If a user makes a reservation for a restaurant online, the time of the reservation and the name of the restaurant may be automatically inserted in boxes in an activity section by the server 301 of the travelogue website, or may be manually filled in by the user. In one embodiment, when the name of a restaurant is filled in, the server 301 may automatically pull information about the restaurant, e.g., a link to the official website of the restaurant, a map with the location of the restaurant marked, a copy of the menu of the restaurant, featured dishes, other users' comments on the restaurant, or pictures of the restaurant. The user may delete the information he does not like.

The template may be compatible with a word processing application in the user's computer, e.g., Microsoft Word™, and the user may edit and format his travelogue with his mouse and keyboard.

FIG. 3 illustrates a system for producing an online travelogue according to one embodiment of the present invention. The system 300 may have a server 301 and a database 302. The server 301 may be coupled to a number of information websites 310 via the Internet 303. The information websites may be a travel website 310a, an online photo management website 310b, a hotel website 310c, a restaurant website 310d, or a museum website 310e. The server 301 may automatically pull information from these information websites to help a user to create his travelogue.

In one embodiment, the server 301 may receive an email confirming a user's flight reservations, abstract the user's travel information, and store the travel information in the database 302. The travel information may include the user's departure airport, destination airport, departure time and arrival time. The server 301 may automatically write the travel information in boxes 202 to 204 in the template shown in FIG. 2 when the user starts to work on his travelogue.

Similarly, the server 301 may automatically obtain information about hotels a user stayed at, restaurants a user went to, or places a user visited, and store such information in the database 302.

The server 301 may further create a map marked with places that users visited.

In addition to storing information obtained by the server 301 from the information websites 310, the database 302 may also store travelogues created by its registered users.

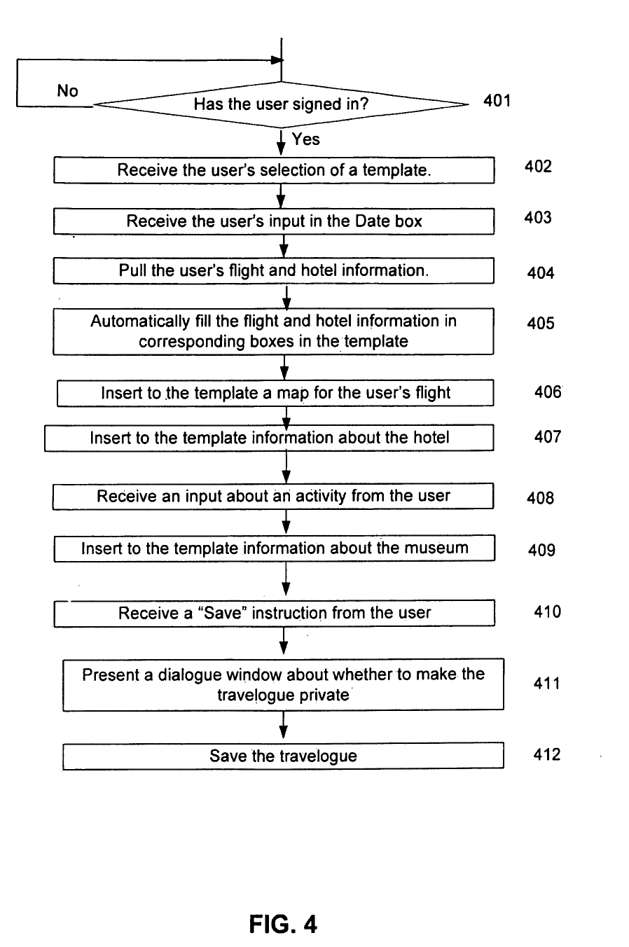

FIG. 4 illustrates a flow chart for producing an online travelogue according to one embodiment of the present invention. The website server may be the server 301 shown in FIG. 3.

At 401, a user may sign in to the travelogue website.

At 402, the user may select a template.

At 403, the user may fill in the Date box 201 with a date, e.g., Oct. 3, 2007.

At 404, the server 301 may search the database 302 with information about the user and the input in the Date box 201. According to a confirmation email from a travel website, the user flew from Chicago to the New York City on Oct. 3, 2007 on flight 971A. According to a confirmation email from the website of a hotel, the user stayed at The Sunshine Inn from Oct. 3 to 7, 2007.

At 405, the server 301 may fill in boxes 202 to 204 and 206 by importing data from the database 302. In one embodiment, the server 301 may produce a new page, following the format of the template, for each day in the chronology. In one embodiment, a button may be provided for the user to turn to different pages of the travelogue.

At 406, the server 301 may create a map of the U.S., with the locations of Chicago and New York City marked and a plane flying from Chicago to New York City, and display the map in the Information box 205.

At 407, the server 301 may obtain information about the hotel Sunshine Inn and add such information in the Information box 207. The information may include the link to the official website of the hotel, other users' comments on the hotel, and a map of New York City with the location of the Sunshine Inn marked.

At 408, the server 301 may receive an input from the user. The input may be, e.g., 1-5 pm in the Time box 221 in an activity section and Metropolitan Museum of Art in the Place box 222.

At 409, the server 301 may automatically obtain information about the Metropolitan Museum of Art and insert the information into the template. The information may include, e.g., a link to the official website of the museum, an introduction to featured works of art displayed at the museum, or other users' comments on the museum. The server 301 may further obtain pictures taken at the museum from, e.g., an online photo management website 310b. In one embodiment, the user may take a picture of a ticket to the museum and upload it to the online photo management website 310b. The server 301 may display the information and the pictures in a window of a search engine or a window of the online photo management website 310b, so that the user may drag the pictures he is interested in and drop them onto the travelogue he is working on.

At 410, the server 301 may receive a “Save” instruction from the user.

At 411, the server 301 may present a dialogue box asking the user whether to save the travelogue as a public version or a “private/password protected” version.

At 412, the server 301 may save the travelogue according to the user's instructions. If the travelogue is saved as a public version, other users may use it as a reference to plan their trips.

Thus, the online travelogue of the present invention may use a template to efficiently organize elements of a trip into a travelogue, may automatically import information from a trip planning process and from other websites, and may have the immediacy of the old-fashioned travel journal.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method for producing an online travelogue, the method comprising:
providing at least one template for an online travelogue on a web page;
receiving a selection of a template;
receiving an input about a trip at a blank space in the selected template to produce a travelogue; and
saving the travelogue in a database.

2. The method of claim 1, wherein the input is travel information.

3. The method of claim 2, wherein the travel information is from a travel website.

4. The method of claim 3, wherein the travel information is abstracted from an email from the travel website.

5. The method of claim 2, wherein the travel information is stored in a database.

6. The method of claim 3, wherein the travel information is automatically imported into the travelogue from the database.

7. The method of claim 2, wherein the travel information is about a place.

8. The method of claim 7, further comprising: automatically obtaining information about the place.

9. The method of claim 8, wherein the information is selected from the group consisting of a link to a website for the place, a map with the location of the place marked, an introduction about the place, comments on the place, and pictures of the place.

10. The method of claim 9, wherein the pictures are from an online photo management website.

11. The method of claim 10, wherein the pictures are uploaded to the online photo management website by the creator of the travelogue.

12. The method of claim 9, further comprising: receiving at the template pictures dropped thereon from an online photo management website.

13. The method of claim 1, further comprising: storing the travelogue as a private version, inaccessible to unauthorized users.

14. The method of claim 1, further comprising: making each page of the travelogue correspond to a respective day of travel.

15. The method of claim 14, further comprising: providing a button for turning from one page of the travelogue to another page.

16. The method of claim 1, further comprising displaying the travelogue on the a web page.

17. The method of claim 1, further comprising: enabling text search in the database.

18. The method of claim 1, further comprising: receiving comments on the travelogue in the database.

19. A computer program product comprising a computer-readable medium having instructions which, when executed on a computer, perform a method of producing an online travelogue, the method comprising:
providing at least one template for an online travelogue on a web page;
receiving a selection of a template;
receiving an input about a trip at a blank space in the selected template to produce a travelogue; and
saving the travelogue in a database.

20. The computer program product of claim 19, further comprising: abstracting travel information from a travel website.

21. The computer program product of claim 20, further comprising: storing the travel information in a database.

22. The computer program product of claim 19, further comprising: displaying the travelogue on the a web page.

23. A system for producing an online travelogue, the system comprising:
a server for providing at least one template for an online travelogue on a travelogue website; and
a database for storing online travelogues,
wherein the server receives a selection of a travelogue template, and starts to produce a travelogue responsive to particular input about a trip at a respective blank space in the selected template.

24. The system of claim 23, wherein the server automatically pulls information about a trip from a second website and stores the pulled information in the database.
